(19) United States
(12) Patent Application Publication
(10) Pub. No.: US 2004/0051319 A1
(43) Pub. Date: Mar. 18, 2004

(54) Starter

(75) Inventors: Kazushige Okumoto, Kariya-shi (JP); Masami Niimi, Handa-shi (JP); Shinji Usmi, Okazaki-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/656,174

(22) Filed: Sep. 8, 2003

(30) Foreign Application Priority Data
Sep. 12, 2002 (JP) 2002-266875

(51) Int. Cl. F02N 11/00; F02N 15/06

(52) U.S. Cl. 290/41; 290/38 A

(57) ABSTRACT

Two or more rolling-contact bearings, each having rolling members, are aligned in an axial direction. A pinion shaft, inserted in an inner cylindrical bore of each rolling-contact bearing, is supported by a housing via the rolling-contact bearings. The pinion shaft is disposed rotatably on the output shaft via a plain bearing and is shiftable on the output shaft in the axial direction. A pinion gear is attached in a cantilever fashion to a distal end of the pinion shaft opposed to the motor. The pinion gear selectively meshes with a ring gear of an engine in a startup operation to transmit the rotational force of a motor to the ring gear.

### BACKGROUND OF THE INVENTION

This invention relates to a starter having a cantilever structure in which a pinion gear is attached on a distal end of a pinion shaft shiftably coupled around an output shaft of the starter.

FIG. 5 shows a conventional starter 100 having a cantilever structure, for example, disclosed in the Japanese Patent Application Laid-open No. 62-131972(1987) or in the Japanese Patent Publication No. 6-47982(1994).

The starter 100 includes a motor 110, a rotary output shaft 120 driven by the motor 110, a cylindrical pinion shaft 160 supported by a housing 140 via a ball bearing 130 and coupled around the output shaft 120 via a plain bearing 150, a pinion gear 170 attached to a distal end (i.e., the left end in the drawing) of the pinion shaft 160 and supported in a cantilever fashion, and a one-way clutch 180 engaged with the output shaft 120 via a helical spline coupling so as to be shiftable on the output shaft 120 together with the pinion shaft 160 in an axial direction.

However, according to the above-described starter 100 characterized by the arrangement of the pinion gear 170 attached to the distal end of the pinion shaft 160, due to its cantilever structure, a unbalanced load (high load) is imparted on the pinion gear 170 when the pinion gear 170 is brought into engagement with a ring gear 190 of the engine to start the engine. A large bending moment acts on the pinion shaft 160. The plain bearing 150, disposed between the pinion shaft 160 and the output shaft 120, is provided with a tiny clearance against the output shaft 120 to reduce sliding resistance. Due to this clearance, the pinion shaft 160 inclines with respect to the output shaft 120 when it is driven. As a result, a significant twist is caused between the pinion shaft 160 and the output shaft 120. This results in driving loss. The motor output is reduced, accordingly.

### SUMMARY OF THE INVENTION

In view of the above-described problems, the present invention has an object to provide a starter capable of suppressing inclination of a pinion shaft when it is driven and also capable of reducing a twisting movement caused between the pinion shaft and an output shaft.

In order to accomplish the above and other related objects, the present invention provides a first starter including a motor generating a rotational force from its armature and a rotary output shaft driven by the motor. Two or more rolling-contact bearings, each having rolling members, are aligned in an axial direction. A pinion shaft is inserted in an inner cylindrical bore of each rolling-contact bearing so as to be supported by a housing via the rolling-contact bearings. The pinion shaft is disposed rotatably on the output shaft via a plain bearing. And, the pinion shaft is shiftable on the output shaft in the axial direction. A pinion gear is attached in a cantilever fashion to a distal end of the pinion shaft opposed to the motor. The pinion gear selectively meshes with a ring gear of an engine in a startup operation to transmit the rotational force of the motor to the ring gear.

According to this arrangement, the pinion shaft can be stably supported by a plurality of rolling-contact bearings aligned extensively in the axial direction. Even if an unbalanced load acts on the pinion gear when the pinion gear meshes with the ring gear to drive the ring gear, it is possible to prevent the pinion shaft from inclining. As a result, no twist is caused between the pinion shaft and the output shaft. It becomes possible to reduce the driving loss. The output reduction of the motor can be minimized.

Furthermore, aligning a plurality of rolling-contact bearings in the axial direction is effective in increasing the contact surface of the bearings contacting to the pinion shaft and to the housing. Heat transmitted from the inside of the motor to the pinion shaft can be effectively transmitted or released to the housing via the plurality of bearings. As a result, it becomes possible to reduce the inner temperature of the motor. The temperature of each rolling-contact bearing can be reduced, too. Thermal damage of the motor can be reduced. The lifetime of each bearing can be extended.

Furthermore, providing an axially extended contact surface between the rolling-contact bearings and the pinion shaft is effective to prevent water components or dusts from entering inside the housing of the starter.

Furthermore, supporting the pinion shaft by the plurality of rolling-contact bearings is advantageous in reducing a load imparted on individual bearing. As a result, it becomes possible to reduce the outer diameter of each bearing. The housing nose portion can be downsized in the radial direction and can be easily installed in a crowded engine room of an automotive vehicle.

Preferably, the rolling-contact bearings include a first rolling-contact bearing and a second rolling-contact bearing arranged next to each other in the axial direction with a predetermined clearance therebetween.

In this case, the space between the first and second rolling-contact bearings can be utilized as an oil reservoir. More specifically, when the pinion shaft shifts in the axial direction, excessive oil adhering on the surface of the pinion shaft is forcibly pushed or squeezed toward the rolling-contact bearings and is stored in this oil reservoir. Sliding performance of the pinion shaft is adequately kept for a long time.

Furthermore, the oil stored in the oil reservoir between the first and second bearings forms a long-lasting oil film spreading in the clearance between each rolling-contact bearing and the pinion shaft. The oil film reduces the sliding resistance of the pinion shaft and prevents water components or dusts from entering inside the housing.

Preferably, each of the rolling-contact bearings is a ball bearing having balls serving as rolling members.

Preferably, each of the rolling-contact bearings has rollers or needles serving as rolling members.

Furthermore, the present invention provides a second starter including a motor generating a rotational force from its armature and a rotary output shaft driven by the motor. The second starter includes a ball bearing having two or more rows of balls which are aligned in an axial direction and interposed between a pair of external and internal rings. A pinion shaft is inserted in an inner cylindrical bore of the ball bearing so as to be supported by a housing via the ball bearing. The pinion shaft is disposed rotatably on the output shaft via a plain bearing. And, the pinion shaft is shiftable on the output shaft in the axial direction. A pinion gear is attached in a cantilever fashion to a distal end of the pinion shaft opposed to the motor. The pinion gear selectively meshes with a ring gear of an engine in a startup operation to transmit the rotational force of the motor to the ring gear.

According to this arrangement, the axial length of the ball bearing becomes wide. Thus, the pinion shaft can be stably supported by the wide ball bearing. Even if an unbalanced load acts on the pinion gear when the pinion gear meshes with the ring gear to drive the ring gear, it is possible to prevent the pinion shaft from inclining. As a result, no twist is caused between the pinion shaft and the output shaft. It becomes possible to reduce the driving loss. The output reduction of the motor can be minimized.

Furthermore, using the ball bearing wide in the axial direction is effective in increasing the contact surface of the bearing contacting to the pinion shaft and to the housing. Heat transmitted from the inside of the motor to the pinion shaft can be effectively transmitted or released to the housing via the wide bearing. As a result, it becomes possible to reduce the inner temperature of the motor. The temperature of each ball bearing can be reduced, too. Thermal damage of the motor can be reduced. The lifetime of each bearing can be extended.

Furthermore, providing an axially extended contact surface between the ball bearing and the pinion shaft is effective to prevent water components or dusts from entering inside the housing of the starter.

Furthermore, supporting the pinion shaft by the plurality rows of balls of the ball bearing is advantageous in reducing a load imparted on individual rows of the balls. As a result, it becomes possible to reduce the outer diameter of the bearing. The housing nose portion can be downsized in the radial direction and can be easily installed in a crowded engine room of an automotive vehicle.

Preferably, the first or second starter further includes a one-way clutch coupled around the output shaft via a helical spline coupling and shiftable on the output shaft in the axial direction together with the pinion shaft to transmit rotation of the output shaft to the pinion shaft. An axial end of the rolling-contact (e.g., ball) bearing closer to the motor is disposed closely to the one-way clutch when the pinion shaft is positioned far from the motor to engage the pinion gear to the ring gear.

In general, lubrication oil is stored inside the one-way clutch. The lubrication oil, when heated, may come out of the one-way clutch. According to the above-described arrangement, the oil coming out of the one-way clutch reaches the rolling-contact bearing via the pinion shaft and lubricates the rolling-contact bearing. The lifetime of each rolling-contact bearing can be extended.

Preferably, the first or second starter further includes a one-way clutch coupled around the output shaft via a helical spline coupling and shiftable on the output shaft in the axial direction together with the pinion shaft to transmit rotation of the output shaft to the pinion shaft. A coupling clearance of the helical spline coupling is larger than a clearance between the rolling-contact (e.g., ball) bearing and the pinion shaft.

According to the conventional starter, it was necessary to employ an accurate helical spline (i.e., having a small coupling clearance) between the one-way clutch and the output shaft to prevent the pinion shaft from inclining. On the contrary, according to the present invention, inclining movement of the pinion shaft can be effectively prevented by the rolling-contact (e.g., ball) bearing. Thus, it becomes possible to increase the coupling clearance of the helical spline. As a result, it becomes possible to lower the required machining accuracy of the helical splines. The machining costs can be suppressed.

Preferably, in the first or second starter, a clearance between the plain bearing and the output shaft is larger than a clearance between the rolling-contact (e.g., ball) bearing and the pinion shaft.

According to this arrangement, even if the pinion shaft inclines with respect to the rolling-contact bearing by the maximum amount equivalent to the above clearance, no twist is caused between the inclined pinion shaft and the output shaft. Thus, the pinion shaft rotates smoothly. As a result, it becomes possible to reduce the driving loss. The output reduction of the motor can be minimized.

Preferably, in the first or second starter, a speed reduction device is disposed between the armature and the output shaft to reduce rotation of the armature and transmit reduced rotation to the output shaft.

In general, the starter having the speed reduction device produces a large torque and is subjected to a large unbalanced load applied on the pinion gear when the ring gear meshes with the pinion gear. Hence, the twist if caused due to inclination of the pinion shaft induces a large loss. Accordingly, the above-described arrangement for preventing the pinion shaft from inclining can be preferably employed for the starter equipped with the speed reduction device. Thus, the driving loss can be effectively reduced.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a partly cross-sectional view showing a non-operated condition of a starter in accordance with a first embodiment of the present invention;

FIG. 2 is a partly cross-sectional view showing an engine startup condition of the starter in accordance with the first embodiment of the present invention;

FIG. 3 is a partly cross-sectional view showing a starter in accordance with a second embodiment of the present invention;

FIG. 4 is a partly cross-sectional view showing a starter in accordance with a third embodiment of the present invention; and

FIG. 5 is a partly cross-sectional view showing a conventional starter.

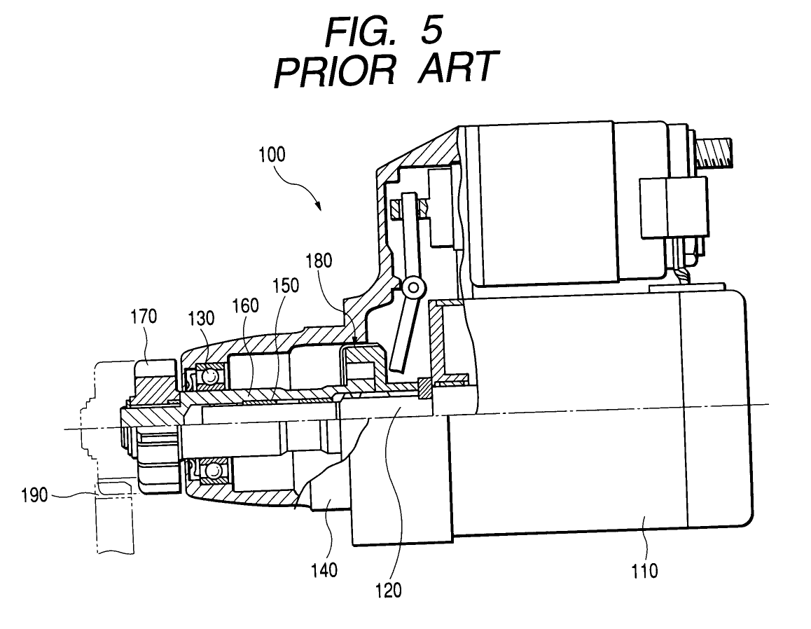

### DESCRIPTION OF THE PREFERRED EMBODIMENTS

Preferred embodiments of the present invention will be explained hereinafter with reference to attached drawings.

### First Embodiment

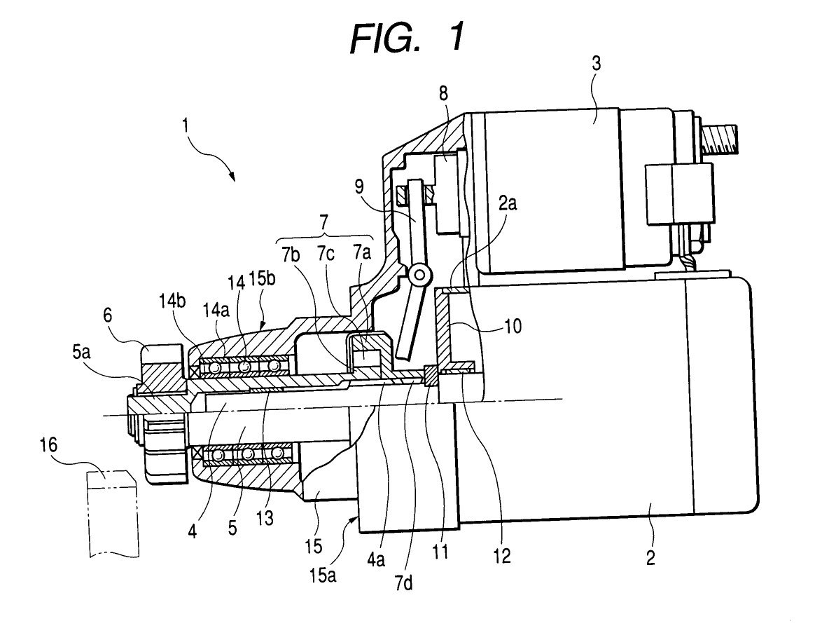

FIG. 1 shows an overall arrangement of a starter 1 in accordance with a first embodiment of the present invention.

The starter 1 of the first embodiment includes a motor 2 generating a rotational force from its armature (not shown), an electromagnetic switch 3 which controls ON/OFF of electric current supplied to the motor 2, a rotary output shaft 4 driven by the motor 2, a pinion shaft 5 coupled around the output shaft 4 so as to be slidable in the axial direction, a pinion gear 6 attached to a distal end (i.e., an axial end far from the motor 2) of the pinion shaft 5, and a one-way clutch 7 transmitting rotation of the output shaft 4 to the pinion shaft 5.

The motor 2 is a well-known DC (i.e., direct-current) motor. When the electromagnetic switch 3 closes a motor contact (not shown), electric power is supplied from a vehicle battery (not shown) to the motor 2. In response to the supplied electric power, the motor 2 generates magnetic field for rotating the armature.

The electromagnetic switch 3 includes a coil (not shown) which is supplied electric power in response to the turning-on operation of an IG (i.e., ignition) key. The electromagnetic switch 3 includes a plunger 8 which is disposed in a cylindrical bore of this coil and is slidable in the axial direction. When the coil is activated in response to supplied electric power, the plunger 8 is magnetically attracted to a predetermined direction (e.g., the right direction in the drawing). The plunger 8 shifts against a resilient force of a return spring (not shown) and closes the motor contact. The axial shift movement of the plunger 8 is transmitted to the one-way clutch 7 via a lever 9. The one-way clutch 7 is thus pushed to a direction departing from the motor 2.

The output shaft 4 is integrally provided with a rotary shaft (i.e., armature shaft) of the motor 2. The output shaft 4 protrudes forward (i.e., leftward in FIG. 1) from a center plate 10. The output shaft 4 is partly configured into an external helical spline 4a. A stopper 11 is provided at the rear side of the external helical spline 4a (i.e., at one side closer to the motor 2). The stopper 11 regulates a stationary position of the one-way clutch 7.

The center plate 10 closes a clutch opening (i.e., the left side opening) of a motor yoke 2a, and also supports the output shaft 4 rotatably via the plain bearing 12.

The pinion shaft 5 has a shaft portion 5a formed with a straight spline (not shown) at its front end. The pinion shaft 5 has a cylindrical sleeve portion formed continuously from the rear end of the shaft portion 5a. A plain bearing 13 is press-fitted into an inner cylindrical bore of the cylindrical sleeve portion of the pinion shaft 5. Thus, the pinion shaft 5 is coupled around an outer cylindrical surface of the output shaft 4 via the plain bearing 13. On the other hand, an outer cylindrical surface of the pinion shaft 5 is supported by a housing 15 via a set of a plurality of (e.g., three in FIG. 1) rolling-contact bearings 14 aligned in the axial direction. A tiny clearance (hereinafter referred to as ‘CB’) is provided between the plain bearing 13 and the output shaft 4.

The pinion gear 6 meshes with a ring gear 16 of an engine in a startup operation to transmit the rotational force of the motor 2 to the ring gear 16. The pinion gear 6 is fixed to the shaft portion 5a of the pinion shaft 5 by spline coupling, and accordingly rotates together with the pinion shaft 5.

The housing 15 has an installation surface 15a to be attached to the engine. The housing 15 has a nose portion 15b configured into a cylindrical shape and protruding from the installation surface 15a in the axial direction departing from the motor 2.

Each rolling-contact bearing includes an outer race 14a and an inner race 14b. The outer race 14a is press-fitted to an inner cylindrical wall of the nose portion 15b. A tiny clearance (hereinafter referred to as ‘CA’) is provided between an inner race 14b and the pinion shaft 5. The clearance ‘CA’ between the bearing 14 (i.e., inner race 14b) and the pinion shaft 5 is set to be smaller than the clearance ‘CB’ between the plain bearing 13 and the output shaft 4.

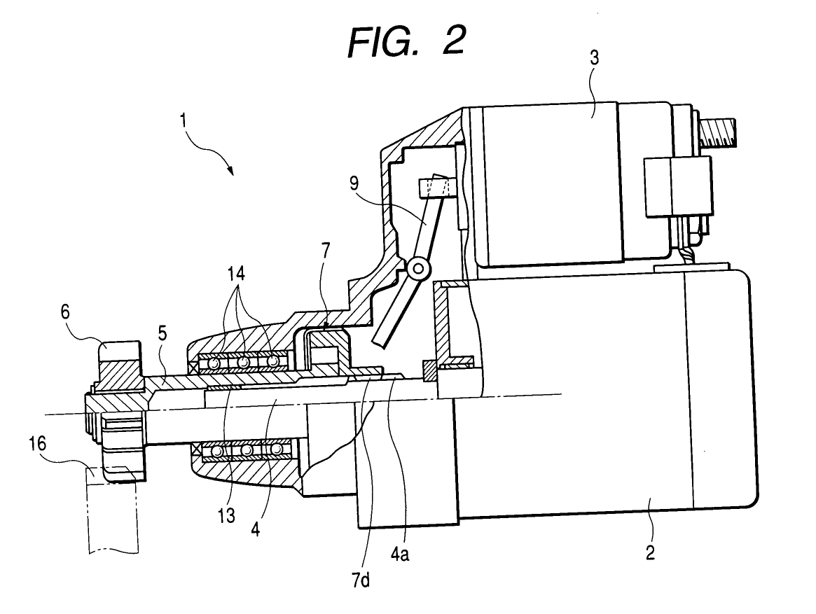

The rightmost bearing 14 is disposed very closely to the one-way clutch 7 when the pinion shaft 5 is positioned far from the motor 2 to engage the pinion gear 6 to the ring gear 16, as shown in FIG. 2.

The one-way clutch 7 is a roller type clutch preferably used for the starter 1. The one-way clutch 7 consists of an outer member 7a, an inner member 7b, and a roller 7c.

The outer member 7a is integrally formed with a cylindrical barrel portion which has an inner cylindrical surface on which an internal helical spline 7d is formed. The barrel portion couples around an outer cylindrical surface of the output shaft 4. The internal helical spline 7d of the barrel portion meshes with the external helical spline 4a of the output shaft 4. A coupling clearance (hereinafter referred to as ‘CC’) between the internal helical spline 7d and the external helical spline 7a is set to be larger than the clearance ‘CA’ between the bearing 14 and the pinion shaft 5.

An end portion of the lever 9, transmitting the axial shift movement of the plunger 8, engages with an outer cylindrical portion of the barrel portion.

The inner member 7b is a cylindrical member integrally formed with the pinion shaft 5 and is disposed inside the outer member 7a in the radial direction.

The roller 7c is disposed in a wedged space defined between the outer member 7a and the inner member 7b. When the outer member 7a rotates together with the output shaft 4, the roller 7c is locked between the outer member 7a and the inner member 7b. Thus, rotation of the outer member 7a is transmitted to the inner member 7b via the locked-up roller 7c. When the rotational speed of the pinion shaft 5 exceeds the rotational speed of the output shaft 4, the roller 7c is unlocked from the engagement with the outer member 7a and the inner member 7b and rotates freely. Hence, no driving force is transmitted between the outer member 7a and the inner member 7b.

The starter 1 operates in the following manner.

In response to the turning-on operation of the IG key, the coil of electromagnetic switch 3 is energized to magnetically attract the plunger 8. The movement of the plunger 8 shifting in the axial direction is transmitted to the one-way clutch 7 via the lever 9. The one-way clutch 7 receives a pushing force from the lever 9 acting in the axial direction departing from the motor 2. The one-way clutch 7 shifts forward (i.e., the axial direction departing from the motor 2) together with the pinion shaft 5. The pinion gear 6 is then brought into contact with the ring gear 16 and is stopped.

Meanwhile, when the plunger 8 is positioned at a predetermined position where the motor contact is closed, electric power is supplied to the motor and accordingly the armature of the motor 2 rotates in response to the supplied electric power. The rotational force of the armature is transmitted to the output shaft 4. Rotation of the output shaft 4 is then transmitted to the pinion shaft 5 via the one-way clutch 7. When the pinion gear 6 rotates to an angular position engageable with the ring gear 16, the pinion shaft 5 receives a thrust force caused between the helical splines 4a and 7d and is pushed forward. Accordingly, the pinion gear 6 meshes with the ring gear 16 (refer to FIG. 2). The rotational force of the motor 2 is transmitted to the ring gear 16 via the pinion gear 6 for cranking of the engine.

When the pinion gear 6 engages with the ring gear 16 to drive the ring gear 16, the pinion gear 6 receives a load as a reaction force from the ring gear 16. In this case, as the pinion shaft 5 supports the pinion gear 6 in a cantilever fashion, a bending moment acts on the pinion shaft 5. This bending moment acts as a force inclining the pinion shaft 5. However, the above-described first embodiment provides a plurality of rolling-contact bearings 14 aligned in the axial direction to support the pinion shaft 5. This effectively prevents the pinion shaft 5 from inclining.

Furthermore, the clearance ‘CB’ between the plain bearing 13 and the output shaft 4 is larger than the clearance ‘CA’ between the bearing 14 and the pinion shaft 5. Accordingly, even if the pinion shaft 5 inclines with respect to the bearing 14 by the maximum amount equivalent to the clearance ‘CA’, no twist is caused between the inclined pinion shaft 5 and the output shaft 4. Thus, the pinion shaft 5 rotates smoothly. As a result, it becomes possible to reduce the driving loss. The output reduction of the motor 2 can be minimized.

Furthermore, aligning a plurality of rolling-contact bearings 14 in the axial direction is effective in increasing the contact surface of the bearings contacting to the pinion shaft 5 and to the housing 15. Heat transmitted from the inside of motor 2 to the pinion shaft 5 can be effectively transmitted or released to the housing 15 via the plurality of bearings 14. As a result, it becomes possible to reduce the inner temperature of the motor 2. Thermal damage of the motor 2 can be reduced. The temperature of the bearings 14 can be lowered. The lifetime of each bearing 14 can be extended.

Furthermore, providing an axially extended contact surface between the plurality of bearings 14 and the pinion shaft 5 is effective to prevent water components or dusts from entering inside the housing 15 from the opening of the nose portion 15b.

Furthermore, supporting the pinion shaft 5 by the plurality of bearings 14 is advantageous in reducing a load imparted on individual bearing 14. As a result, it becomes possible to reduce the outer diameter of each bearing 14. The housing nose portion 15b can be downsized in the radial direction and can be easily installed in a crowded engine room of an automotive vehicle.

Furthermore, the rightmost bearing 14 is disposed very closely to the one-way clutch 7 when the pinion shaft 5 is positioned far from the motor 2 to engage the pinion gear 6 to the ring gear 16. This is advantageous in that oil component coming out of the one-way clutch 7 reaches the bearings 14 via the pinion shaft 5 and lubricates the bearings 14. The lifetime of each bearing 14 can be extended.

According to the conventional starter, it was necessary to employ an accurate helical spline (i.e., having a small coupling clearance) between the one-way clutch and the output shaft to prevent the pinion shaft 5 from inclining. On the contrary, according to the above-described first embodiment of the present invention, inclining movement of the pinion shaft 5 can be effectively prevented by the plurality of rolling-contact bearings 14. Thus, it becomes possible to increase the coupling clearance ‘CC’ between the internal helical spline 7d and the external helical spline 4a. The coupling clearance ‘CC’ is set to be larger than the clearance ‘CA’ between the bearing 14 and the pinion shaft 5. As a result, it becomes possible to lower the required machining accuracy of the helical splines 7d and 4a. The machining costs can be suppressed.

### Second Embodiment

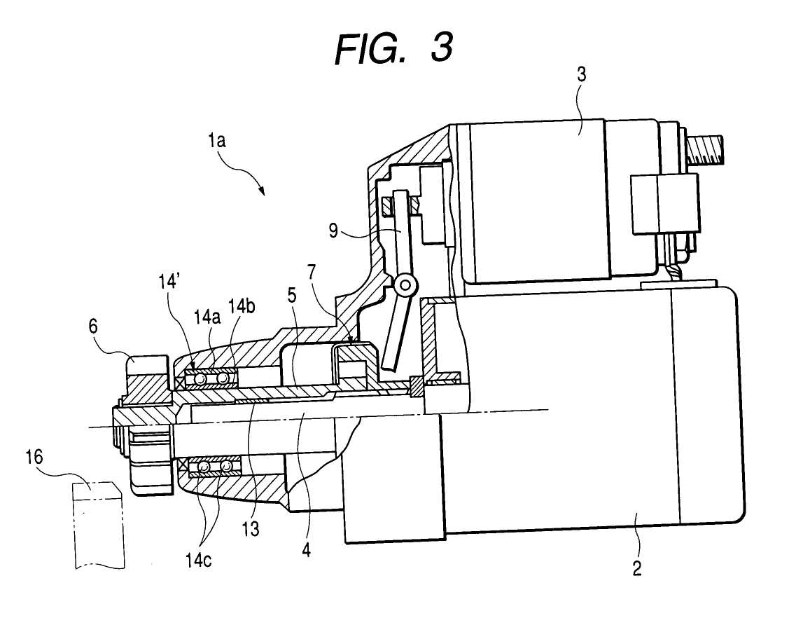

FIG. 3 shows an overall arrangement of a starter 1a in accordance with a first embodiment of the present invention.

The starter 1a of the second embodiment, as shown in FIG. 3, has only one rolling-contact bearing 14′ supporting the pinion shaft 5. According to the second embodiment, the rolling-contact bearing 14′ is a ball bearing including a plurality rows (e.g., two rows) of balls 14c disposed in the axial direction between the outer race 14a and the inner race 14b. In other words, the axial length of the bearing 14′ (i.e., the axial length of the outer race 14a or inner race 14b) in the second embodiment is longer than that of each bearing 14 disclosed in the first embodiment.

According to the second embodiment, it becomes possible to obtain substantially the same effects as those of the first embodiment without providing a plurality of bearings.

The rest of the starter 1a according to the second embodiment is substantially the same as that of the starter 1 disclosed in the first embodiment.

### Third Embodiment

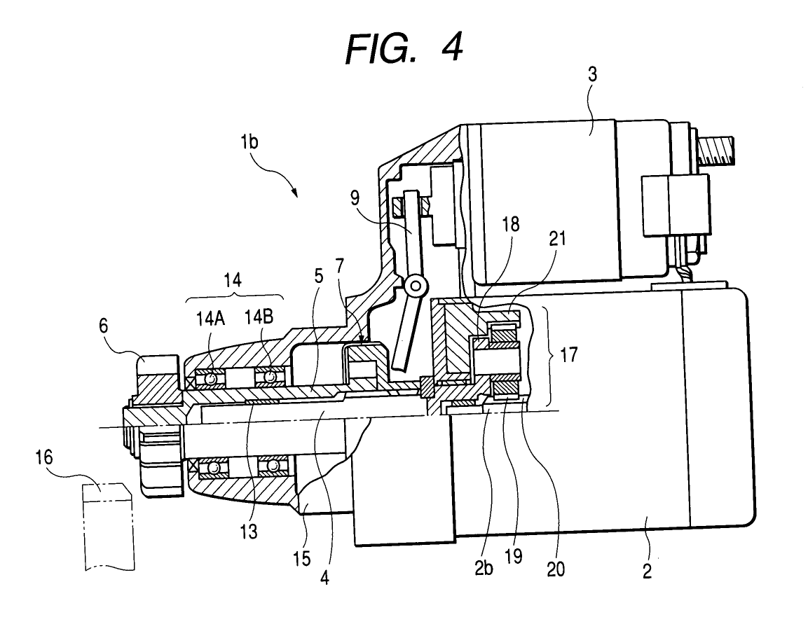

FIG. 4 shows an overall arrangement of a starter 1b in accordance with a third embodiment of the present invention.

The starter 1c of the third embodiment, as shown in FIG. 4, has a first bearing 14A and a second bearing 14B (e.g., ball bearings) which are disposed next to each other and spaced from each other with a predetermined distance in the axial direction for supporting the pinion shaft 5.

According to the arrangement of the third embodiment, in addition to the effect of the first embodiment, the axial space between the first bearing 14A and the second bearing 14B can be utilized as an oil reservoir. More specifically, when the pinion shaft 5 shifts in the axial direction, excessive oil adhering on the surface of the pinion shaft 5 is forcibly pushed or squeezed toward the bearings 14 and is stored in the oil reservoir between the first bearing 14A and the second bearing 14B. Sliding performance of the pinion shaft 5 is adequately kept for a long time.

Furthermore, the oil stored in the oil reservoir between the first bearing 14A and the second bearing 14B forms a long-lasting oil film spreading in the clearance between each bearing 14 and the pinion shaft 5. The oil film reduces the sliding resistance of the pinion shaft 5 and prevents water components or dusts from entering inside the housing 15.

Furthermore, the starter 1b of the third embodiment includes a speed reduction device 17 disposed between the armature and the output shaft 4. Rotation of the armature is reduced by the speed reduction device 17 and is transmitted to the output shaft 4.

The speed reduction device 17, as shown in FIG. 4, is a planetary gear type speed reduction device which includes an armature shaft 2b coaxial with the output shaft 4, a carrier 18 integral with the output shaft 4, and a plurality of planetary gears 19 rotatably supported by the carrier 18. Each planetary gear 19, meshing with a sun gear 20 at a radially inner side and also meshing with an internal gear 21 at a radially outer side, causes an orbital motion about the sun gear 20 while it rotates about its own axis. Through this speed-reduction mechanism, rotation of the armature is reduced and transmitted to the carrier 18.

In general, the starter 1b having the speed reduction device 17 produces a large torque and is subjected to a large unbalanced load applied on the pinion gear 6 when the ring gear 16 meshes with the pinion gear 6. Hence, the twist if caused due to inclination of the pinion shaft 5 induces a large loss. Accordingly, the starter 1b having the speed reduction device 17 provides a plurality of bearings 14 for preventing the pinion shaft 5 from inclining. Thus, the driving loss can be effectively reduced.

It is needless to say that the speed reduction device 17 can be equally incorporated in the starter of the above-described first or second embodiment.

The rest of the starter 1b according to the third embodiment is substantially the same as that of the starter 1 disclosed in the first embodiment.

### Fourth Embodiment

The rolling-contact bearings of the present invention are not limited to the ball bearings disclosed in the above-described first to third embodiments. For example, it is possible to replace the ball bearings by other type of bearings, such as roller bearings having rollers or needles respectively serving as rolling members.

What is claimed is:

1. A starter comprising:
a motor generating a rotational force from its armature;
a rotary output shaft driven by said motor;
a plurality of rolling-contact bearings aligned in an axial direction, each rolling-contact bearing having rolling members;
a pinion shaft inserted in an inner cylindrical bore of each rolling-contact bearing so as to be supported by a housing via said rolling-contact bearings, disposed rotatably on said output shaft via a plain bearing, and shiftable on said output shaft in the axial direction; and
a pinion gear attached in a cantilever fashion to a distal end of said pinion shaft opposed to said motor, and selectively meshing with a ring gear of an engine in a startup operation to transmit the rotational force of the motor to said ring gear.

2. The starter in accordance with claim 1, wherein said rolling-contact bearings comprise a first rolling-contact bearing and a second rolling-contact bearing arranged next to each other in the axial direction with a predetermined clearance therebetween.

3. The starter in accordance with claim 1, wherein each of said rolling-contact bearings is a ball bearing having balls serving as said rolling members.

4. The starter in accordance with claim 1, wherein each of said rolling-contact bearings has rollers or needles serving as said rolling members.

5. The starter in accordance with claim 1, further comprising a one-way clutch coupled around said output shaft via a helical spline coupling and shiftable on said output shaft in the axial direction together with said pinion shaft to transmit rotation of said output shaft to said pinion shaft,
wherein an axial end of said rolling-contact bearings closer to said motor is disposed closely to said one-way clutch when said pinion shaft is positioned far from said motor to engage the pinion gear to the ring gear.

6. The starter in accordance with claim 1, further comprising a one-way clutch coupled around said output shaft via a helical spline coupling and shiftable on said output shaft in the axial direction together with said pinion shaft to transmit rotation of said output shaft to said pinion shaft,
wherein a coupling clearance of said helical spline coupling is larger than a clearance between said rolling-contact bearings and said pinion shaft.

7. The starter in accordance with claim 1, wherein a clearance between said plain bearing and said output shaft is larger than a clearance between said rolling-contact bearings and said pinion shaft.

8. The starter in accordance with claim 1, wherein a speed reduction device is disposed between said armature and said output shaft to reduce rotation of said armature and transmit reduced rotation to said output shaft.

9. A starter comprising:
a motor generating a rotational force from its armature;
a rotary output shaft driven by said motor;
a ball bearing having a plurality rows of balls which are aligned in an axial direction and interposed between a pair of external and internal rings;
a pinion shaft inserted in an inner cylindrical bore of said ball bearing so as to be supported by a housing via said ball bearing, disposed rotatably on said output shaft via a plain bearing, and shiftable on said output shaft in the axial direction; and
a pinion gear attached in a cantilever fashion to a distal end of said pinion shaft opposed to said motor, and selectively meshing with a ring gear of an engine in a startup operation to transmit the rotational force of the motor to said ring gear.

10. The starter in accordance with claim 9, further comprising a one-way clutch coupled around said output shaft via a helical spline coupling and shiftable on said output shaft in the axial direction together with said pinion shaft to transmit rotation of said output shaft to said pinion shaft,
wherein an axial end of said ball bearing closer to said motor is disposed closely to said one-way clutch when said pinion shaft is positioned far from said motor to engage the pinion gear to the ring gear.

11. The starter in accordance with claim 9, further comprising a one-way clutch coupled around said output shaft via a helical spline coupling and shiftable on said output shaft in the axial direction together with said pinion shaft to transmit rotation of said output shaft to said pinion shaft,
wherein a coupling clearance of said helical spline coupling is larger than a clearance between said ball bearing and said pinion shaft.

12. The starter in accordance with claim 9, wherein a clearance between said plain bearing and said output shaft is larger than a clearance between said ball bearing and said pinion shaft.

13. The starter in accordance with claim 9, wherein a speed reduction device is disposed between said armature and said output shaft to reduce rotation of said armature and transmit reduced rotation to said output shaft.
